(19) United States
(12) Patent Application Publication
(10) Pub. No.: US 2026/0270990 A1
(43) Pub. Date: Sep. 10, 2026

(54) METHODS, COMMUNICATIONS DEVICES, AND INFRASTRUCTURE EQUIPMENT

(71) Applicant: Sony Group Corporation, Tokyo (JP)

(72) Inventors: Shin Horng WONG, Basingstoke (GB); Yassin Aden AWAD, Basingstoke (GB); Basuki PRIYANTO, Lund (SE)

(73) Assignee: Sony Group Corporation, Tokyo (JP)

(21) Appl. No.: 19/167,874

(22) PCT Filed: Mar. 22, 2024
(86) PCT No.: PCT/EP2024/057877

§ 371 Date: Sep. 23, 2025

(30) Foreign Application Priority Data
Mar. 31, 2023 (EP) 23166140.6

(51) Int. Cl. H04W 72/1268; H04W 72/21; H04W 72/231

(52) U.S. Cl. CPC H04W 72/1268; H04W 72/21; H04W 72/231

(57) ABSTRACT

A method of operating a communications device for transmitting uplink data to a wireless communications network via a wireless access interface is disclosed. The method includes determining that uplink data is available for transmission, selecting an uplink transmission occasion within a set of uplink resources of the wireless access interface based on a retransmission indicator associated with the selected uplink transmission occasion, and transmitting an uplink channel carrying the uplink data in accordance with the retransmission indicator. The retransmission indicator specifies whether one or more retransmissions of the uplink channel are to be performed after an initial transmission in the selected uplink transmission occasion.

### BACKGROUND

### Field of Disclosure

The present disclosure relates to communications devices, infrastructure equipment and methods for the transmission and/or reception of data by a communications device in a wireless communications network.

The present application claims the Paris Convention priority from European patent application number EP23166140.6, filed on 31 Mar. 2023, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is extended Reality (XR), which may be provided by various user equipment such as wearable devices. XR combines real-world and virtual environments, incorporating aspects such as augmented reality (AR), mixed reality (MR), and virtual reality (VR), and thus requires high quality and minimised interaction delay. Services such as URLLC and XR therefore represent a challenging example for both LTE type communications systems and 5G/NR communications systems, as well as future generation communications systems.

5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

Some embodiments of the present technique can provide a method of operating a communications device configured to transmit signals to and/or to receive signals from a wireless communications network via a wireless access interface. The method comprises determining that the communications device has uplink data to transmit to the wireless communications network, selecting an uplink transmission occasion within a set of uplink resources of the wireless access interface to carry the uplink data to the wireless communications network, wherein the communications device selects the uplink transmission occasion based on a retransmission indicator associated with the selected uplink transmission occasion that indicates whether or not one or more retransmissions of an uplink channel are to be performed by the communications device after an initial transmission of the uplink channel in the selected uplink transmission occasion, and transmitting the uplink channel carrying the uplink data to the wireless communications network in accordance with the retransmission indicator.

Further embodiments of the present technique can provide a method of operating a communications device configured to transmit signals to and/or to receive signals from a wireless communications network via a wireless access interface. The method comprises receiving, from the wireless communications network, a retransmission indicator associated with a downlink transmission occasion that indicates whether or not one or more retransmissions of a downlink channel to be received by the communications device in the downlink transmission occasion within a set of downlink resources of the wireless access interface from the wireless communications network may be performed by the wireless communications network after an initial transmission of the downlink channel, and receiving the downlink channel from the wireless communications network in accordance with the retransmission indicator, wherein the downlink channel comprises downlink data.

Such embodiments of the present technique, which, in addition to methods of operating communications devices, relate to methods of operating infrastructure equipment, communications devices and infrastructure equipment, circuitry for communications devices and infrastructure equipment, wireless communications systems, computer programs, and computer-readable storage mediums, can allow for the more efficient and effective use of radio resources by a communications device operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of an NR-type wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 is reproduced from [8], and illustrates a traffic model for extended Reality (XR);

FIG. 5 illustrates an example of a New Radio Unlicensed (NR-U) Channel Access on a grid of radio communications resources;

FIG. 6 illustrates an example of Type 1 and Type 2 Dynamic Channel Access (DCA) on an uplink and downlink grid of radio communications resources;

FIG. 7 illustrates examples of Type 2 DCA on a grid of radio communications resources;

FIG. 8 illustrates the time-domain parameters for a Configured Grant of Physical Uplink Shared Channel (CG-PUSCH);

FIG. 9 demonstrates how Redundancy Version (RV) patterns restart during PUSCH repetitions;

FIG. 10 shows an example of how a User Equipment (UE) may be unable to complete PUSCH repetition transmissions;

FIG. 11 illustrates an example of multi CG-PUSCH;

FIG. 12 illustrates an example of a main CG-PUSCH with two supplementary CG-PUSCHs;

FIG. 13 shows a part schematic, part message flow diagram representation of a first wireless communications system comprising a communications device and an infrastructure equipment in accordance with embodiments of the present technique;

FIG. 14 illustrates an example of a Hybrid Automatic Repeat Request (HARQ) retransmission-less logical channel (LCH) in accordance with embodiments of the present technique;

FIG. 15 illustrates various examples of HARQ retransmission-less operation in accordance with embodiments of the present technique;

FIG. 16 shows a flow diagram illustrating a first example process of communications in a communications system in accordance with embodiments of the present technique.

FIG. 17 shows a part schematic, part message flow diagram representation of a second wireless communications system comprising a communications device and an infrastructure equipment in accordance with embodiments of the present technique; and

FIG. 18 shows a flow diagram illustrating a second example process of communications in a communications system in accordance with embodiments of the present technique.

### DETAILED DESCRIPTION OF THE EMBODIMENTS

### Long Term Evolution Advanced Radio Access Technology (4G)

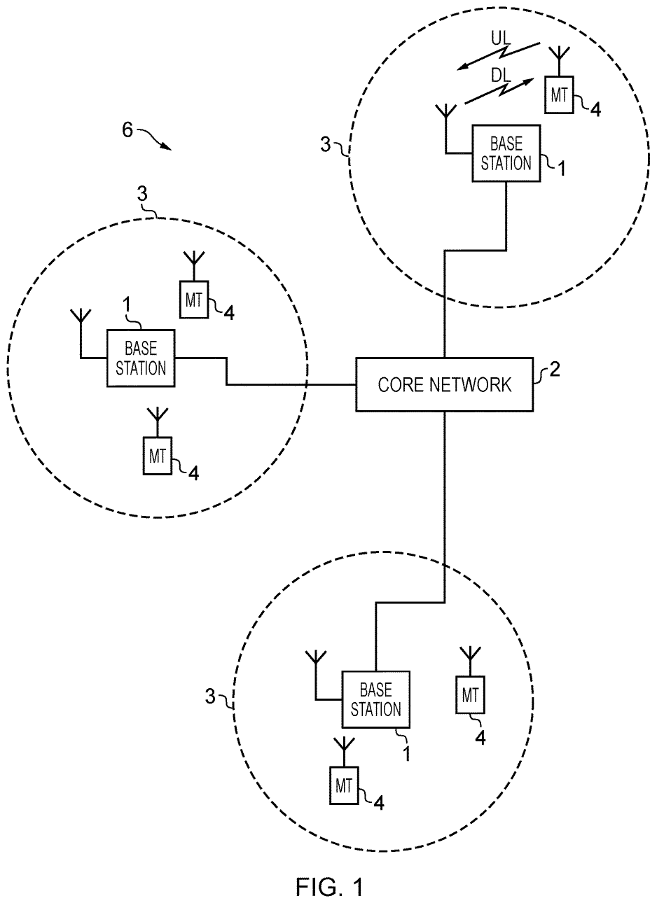

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e., a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e., page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

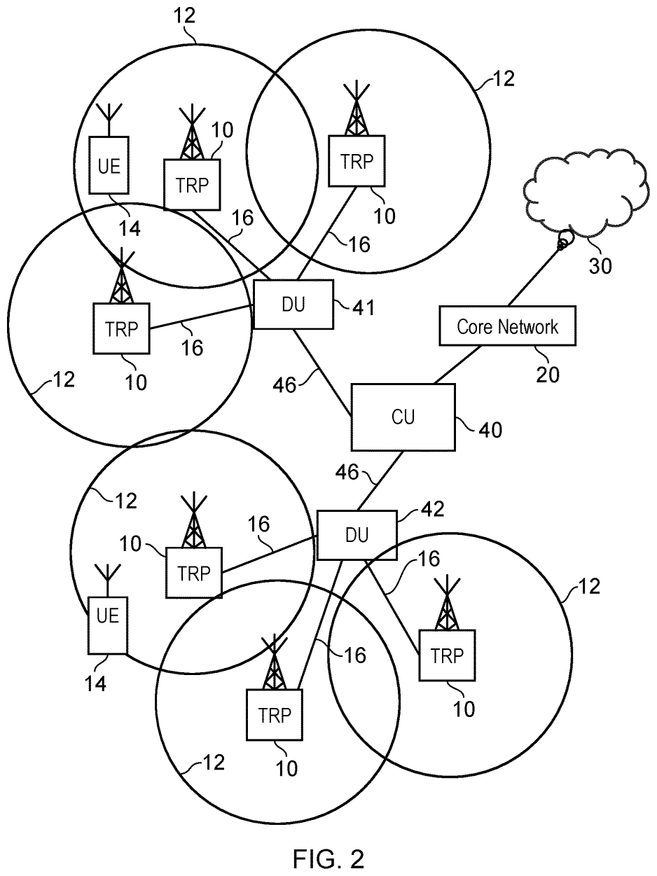

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12.

As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems.

Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

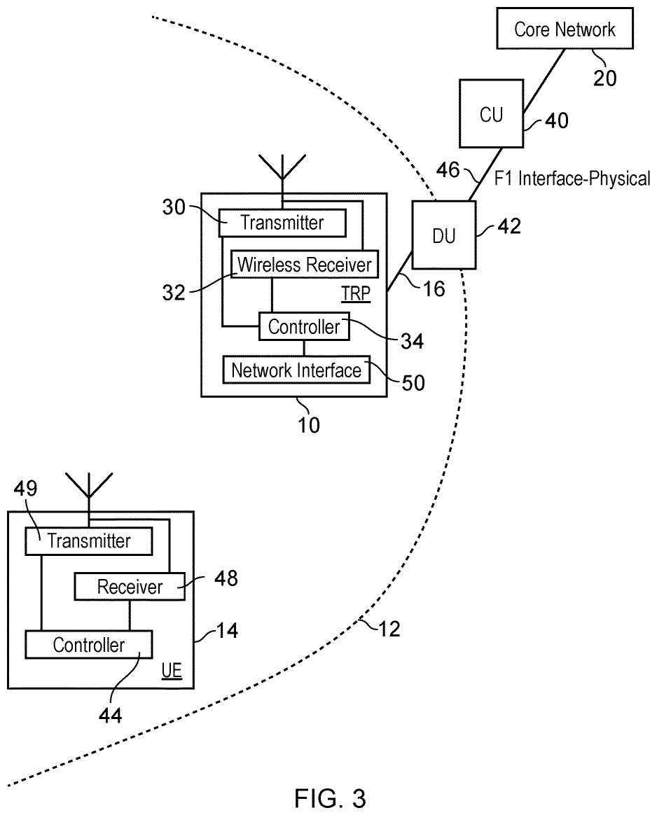

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

eURLLC, NR-U, and Extended Reality

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. A requirement for Ultra Reliable and Low Latency Communications (URLLC) services is that one transmission of a 32 byte packet is required to be transmitted from the radio protocol layer 2/3 SDU ingress point to the radio protocol layer 2/3 SDU egress point of the radio interface within 1 ms with a reliability of 1-105 (99.999%) or higher (99.9999%) [2]. Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

Enhanced URLLC (eURLLC) [3] [4] specifies features that require high reliability and low latency, such as factory automation, transport industry, electrical power distribution, etc. It should be appreciated that the Uplink Control Information (UCI) for URLLC and eMBB will have different requirements.

Another such service incorporating NR technology is 5G NR in Unlicensed Spectrum (NR-U) [5], which enable devices to make use of shared and unlicensed spectrum bandwidth. Such features as Listen Before Talk (LBT), as specified by [5], is incorporated into the NR frame structure for NR-U operation in unlicensed bands.

eXtended Reality (XR) and Cloud Gaming refer to various types of augmented, virtual, and mixed environments, where human-to-machine and human-to-human communications are performed with the assistance of handheld and wearable end user devices (UEs). XR and Cloud Gaming are two more recently developed applications, that are considered important for NR Rel-18 and beyond (also known as 5G Advanced) [6].

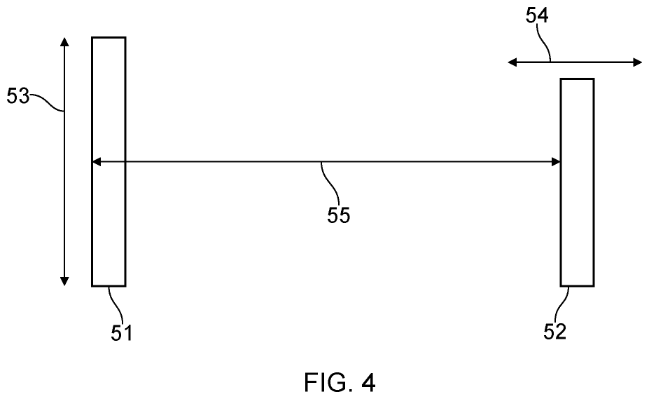

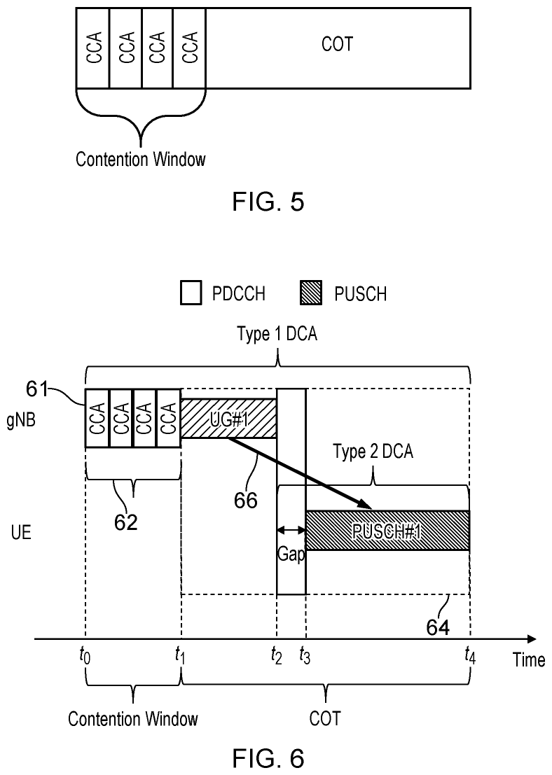

XR traffic is rich in video, especially in the downlink, with a typical frame rate of 60 Hz [7], which leads to a data transmission with non-integer periodicity in NR, i.e. the periodicity is not an integer number of subframes and in this example, the periodicity is 16.67 ms. Due to varying frame encoding delay and network transfer time, the packet arrival at the gNB may experience random jitter. The non-integer and jitter characteristics of XR traffic is known as quasi-periodic traffic. In addition to jitter, the packet size also varies within a range; that is the packet size in each period is random. The jitter and random packet size of UL traffic is illustrated in FIG. 4, which is based on a similar figure (FIG. 5.1.1-1) in [8].

FIG. 4 illustrates a single stream traffic model for XR. A first packet k 51 is transmitted, representing Internet Protocol (IP) packets belonging to video frame k. At a later point in time—which, on average, is the inverse of the frame generation rate (i.e., 1/fps) as denoted by arrow 55—a second packet k+1 52 is transmitted, representing IP packets belonging to video frame k+1. The variable packet size which follows a probability distribution is shown by arrow 53, while the variable jitter which also follows a probability distribution is denoted by arrow 54.

In the legacy 5G system, traffic with known periodicity and packet size, e.g. voice, is supported using Configured Grant of PUSCH (CG-PUSCH) and Semi-Persistent Scheduling (SPS) Physical Downlink Shared Channels (PDSCH). In the legacy system, CG-PUSCH (which is discussed in greater detail below) and SPS assume that the Transport Block Size (TBS) of the PUSCH and PDSCH of the traffic are the same in every period. However, in XR traffic, the payload of a quasi-periodic traffic may not be the same but varies within a range.

### Channel Access in NR-U

In the following paragraphs, an explanation is provided of current proposals for accessing communications from an unlicensed frequency band. In an unlicensed band, two or more systems may operate to communicate using the same communications resources. As a result, transmissions from different systems can interfere with each other especially when for example, each of the different systems are configured according to different technical standards, for example Wi-Fi and 5G. Of course, transmissions from systems operating in accordance with the same standard may also cause interference.

As such, there is a regulatory requirement to use an LBT protocol for each transmitter operating in an unlicensed band to reduce interferences among different systems (either operating according to the same or different technical standards as one another) sharing that band. In LBT, a device that wishes to transmit a packet will firstly sense the band for any energy levels above a threshold to determine if any other device is transmitting, i.e. it listens, and if there is no detected transmission, the device will then transmit its packet. Otherwise, if the device senses a transmission from another device it will back-off and try again at a later time.

In NR-U the channel access can be Dynamic (also known as Load Based Equipment) or Semi-Static (also known as Frame Based Equipment). The dynamic channel access schemes consist of one or more Clear Channel Assessment (CCA) phases in a Contention Window followed by a Channel Occupancy Time (COT) phase as shown FIG. 5. LBT is performed during the CCA phase by an NR-U device (e.g. gNB or UE) that wishes to perform a transmission. According to the CCA phase, the NR-U device listens to one or more of CCA slots and if no other transmission is detected (i.e. energy level is determined to be below a threshold for the duration of the one or more CCA slots) after the CCA phase, the NR-U device moves into the COT phase where it can transmit its packet in the COT resources. In Dynamic Channel Access (DCA) the CCA and COT phases can be of different length between different systems whilst in Semi-static Channel Access, the CCA and COT phases have fixed time windows and are synchronised for all systems sharing the band. Further details on channel access in NR-U may be found in co-pending International patent application with international publication number WO 2022/018230 [9].

In NR-U a device can be an initiating device or a responding device. The initiating device acquires the COT by performing CCA and typically it initiates a first transmission, e.g. a gNB transmitting an uplink grant. The responding device receives the transmission from the initiating device and responds with a transmission to the initiating device, e.g. a UE receiving an uplink grant and transmitting the corresponding PUSCH. As will be appreciated a UE can also be an initiating device, for example when it is transmitting a Configured Grant (CG) PUSCH, and the gNB can be a responding device.

There are two types of Dynamic Channel Access (DCA), which are referred to as Type 1 and Type 2. In a Type 1 DCA, a counter N is generated as a random number between 0 and CWₚ, where a Contention Window size CWₚ is set between CW_{min,p} and CW_{max,p}. The duration of the COT and the values {CW_{min,p}, CW_{max,p}} depend on the value p, which is the Channel Access Priority Class (CAPC) of the transmission. The CAPC may be determined, for example, by a QoS of the transmitting packet. A Type 1 DCA is performed by an initiating device, and once the COT is acquired, one or more responding devices can use Type 2 DCA for their transmissions within the COT. Type 2 DCA may require a short CCA or no CCA prior to transmission if the gap between one transmission of two devices is less than a predefined value, such as, for example, 25 μs. If the gap is greater than this predefined value such as 25 μs, then the responding device needs to perform Type 1 DCA.

FIG. 6 provides an illustration of frequency against time for transmission in an unlicensed band. As shown for the example of FIG. 6, an example of a Type 1 DCA transmission and an example of a Type 2 DCA transmission are shown. According to the example shown in FIG. 6, at time to, the gNB wishes to send an uplink grant, UG #1, to the UE to schedule PUSCH #1. The gNB performs a Type 1 DCA starting with a Contention Window with four CCAs 61, so that for this example the random number N=4, and detects no energy during this Contention Window 62, thereby acquiring the COT 64 between time t₁ to t₄. The gNB then transmits UG #1 to the UE scheduling a PUSCH #1 at time t₃ as represented by arrow 66. The UE receiving the uplink grant UG #1 then can use Type 2 DCA if the gap between UG #1 and the start of its PUSCH #1 transmission, between time t₂ and t₃ is below a threshold, otherwise the UE will have to perform a Type 1 DCA. This is to say, if the granted PUSCH #1 is less than a threshold time from the gNB's transmission of the uplink grant UG #1 or other gNB transmissions, then the UE is not required to make a contention itself for the resources on the unlicensed band by transmitting in the CCA and then COT according to the Type 1 DCA.

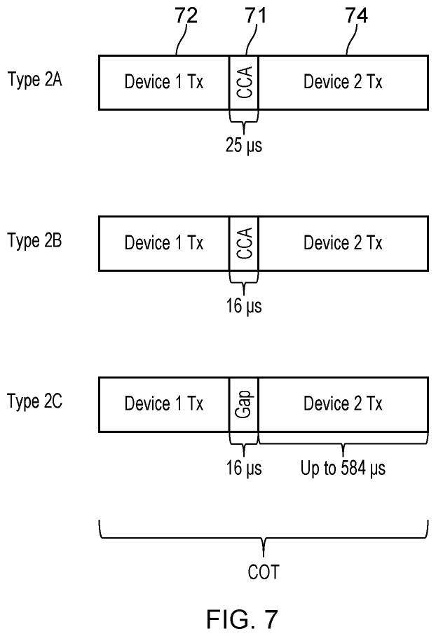

There are three types of Type 2 DCA, as shown in FIG. 7, which are defined with respect to a length of the gap 71 between transmission 72 by a first device (initiating device) and transmission 74 by a second device (responding device) within a COT, and are therefore defined by whether the second responding device needs to perform a CCA. These types are:
Type 2A: The gap between two transmissions is more than 16 s and not more than 25 μs and the UE performs a single clear channel assessment (CCA) within this gap 71;
Type 2B: The gap between two transmissions is not more than 16 μs and the UE performs a single CCA within this gap 71; and
Type 2C: The gap between two transmissions is not more than 16 μs no CCA is required within this gap 71.

A COT can be shared by multiple devices; i.e. a gNB can initiate the COT which it can then share with one or more UE. For example, a gNB can initiate a COT, and then can transmit an UL Grant to a UE, and the UE can then use this COT to transmit the PUSCH. A device using a COT initiated by another device may not need to perform CCA, or may need to perform just a short CCA. Those skilled in the art would appreciate that a UE can also initiate a COT.

### Rel-15 Configured Grant

As is well understood by those skilled in the art, a UE uses a Physical Uplink Shared Channel (PUSCH) for uplink data transmission. The PUSCH resources used for the transmission of the PUSCH can be scheduled by a gNB using a Dynamic Grant (DG) or a Configured Grant (CG).

In a Dynamic Grant PUSCH (DG-PUSCH), the UE typically sends a Scheduling Request (SR) to the gNB when uplink data arrives at its buffer. In response to receiving the SR, the gNB would then send an Uplink Grant, e.g., via Downlink Control Information (DCI) using DCI Format 0_0, 0_1 or 0_2, carried by a Physical Downlink Control Channel (PDCCH) to the UE where this Uplink Grant schedules resources for a PUSCH. The UE then uses the scheduled PUSCH (i.e. DG-PUSCH) to transmit its uplink data.

It is observed that the use of DG-PUSCHs introduces latency, since the UE needs to initiate an SR and has to wait for an Uplink Grant before it is scheduled PUSCH resources. For regular and periodic traffic, DG-PUSCH would lead to multiple SR and Uplink Grants being sent which is not an efficient use of resources. Hence, recognising the drawbacks of DG-PUSCH, Configured Grant of PUSCH (CG-PUSCH) is introduced in NR. In CG-PUSCH, the UE is pre-configured using Radio Resource Control (RRC) configuration periodic PUSCH resources, such that the UE can transmit its uplink data in any of these regularly occurring CG-PUSCH resources without the need to request it with an SR. There are two types of CG-PUSCH:
Type 1 CG-PUSCH: Once the CG-PUSCH resource is configured by RRC, the UE can use it without activation; and
Type 2 CG-PUSCH: The CG-PUSCH resource is firstly RRC configured. The UE can only use the CG-PUSCH resource if it receives an activation DCI, which is an UL Grant with a Configured Scheduling-Radio Network Temporary Identifier (CS-RNTI). Once the CG-PUSCH is activated the UE can use it until it is deactivated by another DCI. Type 2 CG-PUSCH provides better control for the gNB scheduler and therefore more efficiently utilises resources.

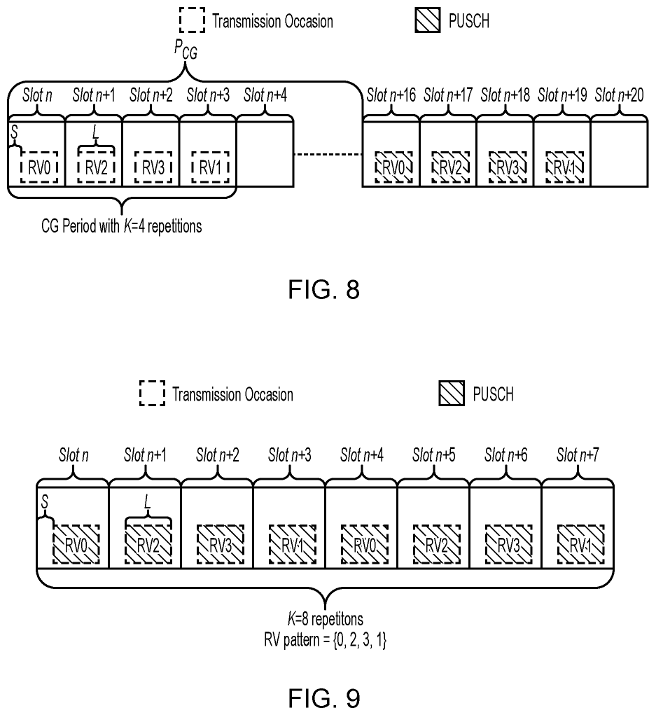

In the time domain, a CG-PUSCH consists of a periodicity P_{CG}, repetitions K={1, 2, 4, 8}, duration L of the PUSCH and starting symbol offset relative to slot boundary S of the PUSCH. An example is shown in FIG. 8, where the CG-PUSCH has a periodicity P_{CG}=224 symbols (or 16 slots), repetition of K=4, duration of L=9 symbols and a starting symbol S=3 symbols from the start of slot boundary. The CG-PUSCH consists of Transmission Occasions (TO), where a TO is an opportunity for the UE to transmit uplink data. It should be noted here that the UE does not need to use a TO, i.e. a CG-PUSCH resource, if it has no uplink data to transmit. For example, in Slot n, the UE does not have any uplink data and so it does not transmit anything in the TOs for that CG period but in the next CG Period starting in Slot n+16, the UE has uplink data and therefore uses the TOs in that CG Period to transmit four repetitions of the uplink data.

The first TO in a CG Period is associated with Redundancy Version RV=0. If repetition K>1, then each TO in the CG Period is associated with an RRC configured RV pattern, where the RV pattern can be {0, 2, 3, 1}, {0, 3, 0, 3} or {0, 0, 0, 0}. The RV pattern is configured in RRC parameter repK-RV. For example, in FIG. 8, the RV pattern={0, 2, 3, 1}. The first PUSCH transmission in a CG Period must always start with RV=0. For repetition K=8, the RV pattern is cycled after the fourth repetition; i.e. the RV pattern restarts after the fourth repetition. For example, in FIG. 9, the RV pattern={0, 2, 3, 1} and K=8 repetitions. Here the UE cycles the RV at the fifth repetition, where the RV pattern is restarted at the fifth TO of the CG period in Slot n+4.

Since Hybrid Automatic Repeat Request (HARQ) is used for PUSCH transmission, each PUSCH is associated with a HARQ Process Number (HPN) where there are 16 HARQ processes, i.e., HPN=0 to 15. In DG-PUSCH, the HPN is indicated in the UL Grant. For CG-PUSCH, since there is no UL Grant, each CG period is associated with an HPN and is dependent upon the starting symbol O_{CG} (in units of symbols) of the first TO in a CG period relative to SFN=0, the periodicity P_{CG} (in units of symbols) and the number of HARQ processes N_{HARQ} configured for the CG-PUSCH [7] (i.e., the gNB can configured less than 16 HARQ processes for a CG-PUSCH), i.e.:

$$HPN = ⌊ \frac{{O}_{C G}}{{P}_{C G}} ⌋ MOD {N}_{H A R Q}$$

Where └.┘ is the Floor function and O_{CG} is relative to the first symbol of the first slot of the radio frame with SFN=0.

Retransmission of a CG-PUSCH is scheduled using an UL Grant. That is, a DG-PUSCH is used for the retransmission of a CG-PUSCH that is not decoded successfully at the gNB. If the UE does not receive an UL Grant for the retransmission of a CG-PUSCH within a pre-configured timer T_{CG-ACK}, the UE will consider that the CG-PUSCH has been received successfully. The timer T_{CG-ACK}, is configured by RRC parameter configuredGrantTimer.

Rel-16 eURLLC CG-PUSCH

Since the first CG-PUSCH transmission must use a TO with RV=0, if the UE misses that TO, it may not be able to transmit any PUSCH in that CG Period. For example, referring back to FIG. 8, if the uplink data arrives at the UE's transmit buffer in Slot n+1, then the UE may only be ready to transmit a PUSCH in Slot n+2 but the TO in Slot n+2 corresponds to RV=3 and so the UE cannot start its PUSCH transmission. It then has to wait till the next CG Period in Slot n+16 for a TO with RV=0 to start its transmission. This introduces latency for the PUSCH transmission, which may not meet the stringent latency requirement in URLLC.

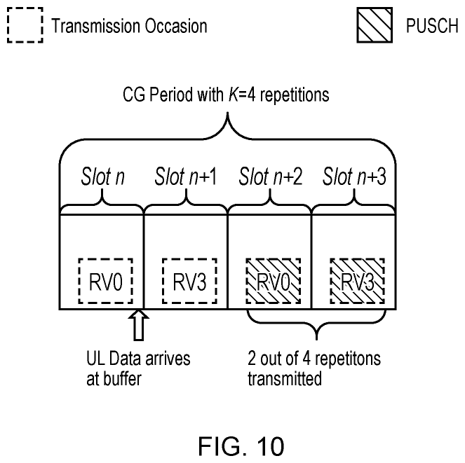

In order to improve reliability, PUSCH is transmitted using repetitions, as has been mentioned above. For CG-PUSCH, if the uplink data does not arrive before the first TO of a CG Period, the UE may not be able to transmit the required number of repetitions, even if there are multiple TOs with RV=0 within that CG Period. For example, in FIG. 10, a CG-PUSCH is configured with K=4 repetitions and an RV pattern {0, 3, 0, 3} thereby allowing two TOs where the first PUSCH transmissions can start (i.e. the first and third TOs). Uplink data arrives at the UE's transmit buffer at the end of Slot n, thereby missing the first TO of the CG Period. Since the UE has to start its PUSCH transmission in a TO with RV=0, the PUSCH is transmitted in Slot n+2, i.e. the closest TO with RV=0. However, there are only two TOs left in that CG Period and so the UE is only able to transmit two out of the targeted four repetitions. The reduced PUSCH repetition transmissions may not meet the strict reliability requirement for URLLC.

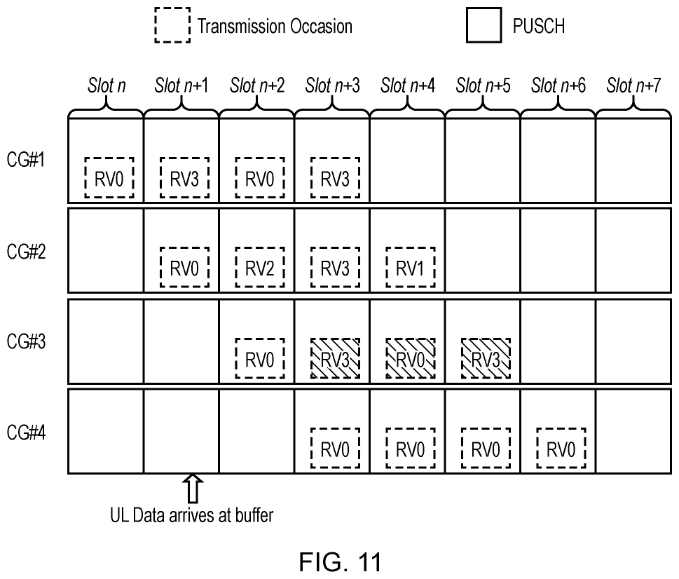

Recognising the drawbacks of Rel-15 CG-PUSCH, multi CG-PUSCH was introduced for Rel-16 eURLLC, where a UE can be configured with up to 12 CG-PUSCH where each CG-PUSCH can be independently configured. A configuration can be made such that different CG-PUSCHs start at different times so that a UE has multiple opportunities to transmit its PUSCH. For example, in FIG. 11, a UE is configured with four CG-PUSCHs, labelled as CG #1, CG #2, CG #3 and CG #4 and each with repetition K=4. These CG-PUSCHs are configured such that they start within one slot offset of one another. At Slot n+1, uplink data arrives at the UE's transmit buffer and the possible TOs that the UE can use to start its PUSCH transmissions are the third TO (Slot n+2) of CG #1, the first TO (Slot n+2) of CG #3 and the first TO (Slot n+3) of CG #4. In order to ensure K=4 repetitions, the UE can use CG #3 or CG #4 but since CG #3 offers the lowest latency, the UE selects CG #3 for its PUSCH transmissions thereby ensuring K=4 repetitions and minimising latency. It would be appreciated by those skilled in the art that the staggering of multiple CG-PUSCH resources as shown in FIG. 11 is just one possible configuration to ensure K repetitions are sent with minimum latency. The gNB is free to configure other arrangements as each CG-PUSCH can be individually configured.

For Type 2 CG-PUSCH, a CG-PUSCH can be individually activated using the four-bit HPN field in an UL Grant. For deactivation, one or more CG-PUSCHs can be indicated for deactivation using the 16 states in the HPN field, where each state can be configured to indicate a combination of CG-PUSCHs for deactivation.

### CG-UCI

In Rel-15 and Rel-16 eURLLC, the HARQ Process Number (HPN) and Redundancy Version (RV) of each CG-PUSCH transmission is fixed for each TO, and is known to the gNB. However, in Rel-16 NR-U, the UE can use any of the TOs for a first PUSCH transmission, and different TBs (i.e. with different HPN) can be transmitted in a CG occasion, and therefore the gNB needs to know the HPN and the RV of these CG-PUSCH. In order to provide this information to the gNB, CG Uplink Control Information (CG-UCI) is introduced for Rel-16 NR-U, which consists of the following fields:
HARQ Process Number (HPN) (indicated by 4 bits);
Redundancy Version (RV) (indicated by 2 bits);
New Data Indicator (NDI) (indicated by 1 bit); and
COT sharing information (indicated by log 2CDL bits, where CDL is the number of entries in a lookup table indicating the locations of DL resources that the gNB can use within the UE initiated COT).

The CG-UCI is multiplexed into the CG-PUSCH transmission.

### Rel-18 Supplementary CG-PUSCH

Supplementary CG-PUSCH is proposed for NR in Rel-18, where additional CG-PUSCHs (i.e. supplementary CG-PUSCHs) can be configured for each of the multiple CG-PUSCHs, and these supplementary CG-PUSCHs can be dynamically activated using CG-UCI in the main (i.e. first) CG-PUSCH. Since the supplementary CG-PUSCHs are dynamically activated, they are only used if required.

If they are not activated, the allocated resources can be reallocated by the gNB to schedule other traffic or UEs. The first CG-PUSCH transmission occasion within a period of the CG-PUSCH configuration is called main CG-PUSCH. The subsequent CG-PUSCH transmission occasion(s) within a period of the CG-PUSCH configuration are called supplementary CG-PUSCH(s).

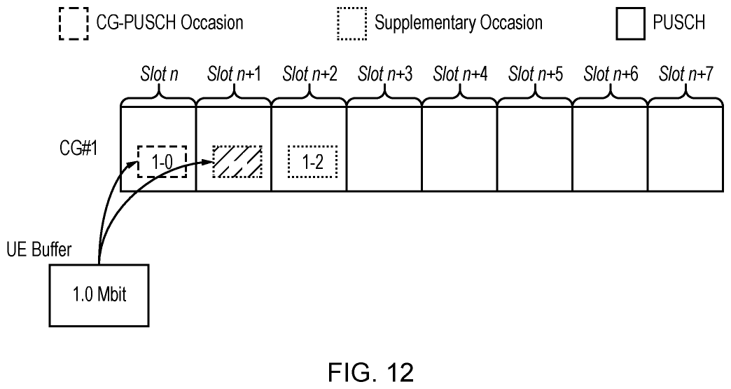

An example of this operation is shown in FIG. 12, where a UE is configured with a CG-PUSCH configuration, CG #1, with K=1 repetitions to support XR traffic. For XR traffic with a minimum TBS of 0.5 Mbits and a maximum TBS of 1.5 Mbits, in order to reduce resource wastage, the CG-PUSCH is configured with a TBS corresponding to the minimum XR packet size of 0.5 Mbit, and with two supplementary CG-PUSCHs (each also 0.5 Mbit in size), thereby allowing the main and supplementary CG-PUSCHs between them to support up to the maximum XR packet size of 1.5 Mbit, if required. In the example of FIG. 12, a UE may have an XR packet of 1.0 Mbit arrive at its buffer ahead of Slot n, and so the UE is therefore able to transmit this XR packet using CG #1. Since the main CG-PUSCH of 0.5 Mbit, labelled as 1-0 in FIG. 12, is not sufficient to empty the UE buffer completely, the CG-UCI transmitted by the UE within the main CG-PUSCH 1-0 activates a supplementary CG-PUSCH 1-1 to carry the remaining 0.5 Mbit of data from the UE's buffer. Since supplementary CG-PUSCH 1-2 is not needed to transmit any of the XR packet, it is not activated by the UE, and hence can be used by the gNB to schedule other traffic or another UE.

It would be appreciated by those skilled in the art that the example of FIG. 12 exemplifies just one way in which supplementary CG-PUSCHs could be implemented, since the details of supplementary CG-PUSCH are not defined yet as they are—at the time of filing the present disclosure-currently being discussed in 3GPP.

One of the pieces information that an XR device needs to transmit is its position and orientation (which can collectively be referred to as its pose) so that the XR application can determine the position at which the user is located and the direction the user is looking and respond appropriately (i.e., tracking of the XR Viewer pose). For example, if a VR headset displaying a virtual room sends pose information to the XR server suggesting the wearer of that VR headset is looking up, the server would display video of the ceiling of that virtual room rather than the floor. In addition to pose information, there may also be other types of control information that an XR device sends to the server on the uplink. Additionally, the XR device may transmit video and/or audio data so that it can be used by the counter-part of the XR user (such as the XR application server for example). Video and/or audio data typically require a large data size and are less time-sensitive. On the other hand, pose/control UL transmissions in XR are typically smaller in size and are a more time-sensitive nature. For example, if a person looks up and then looks down again, the video needs to display the ceiling and the floor accordingly in a timely manner. Since pose/control UL transmission is time-sensitive, if the UL transmission comprising such pose or control information fails, it may not be beneficial to retransmit that information again. For example, if a person looks up and then down, and the pose information when the person looks up fails to reach the server, there is not much benefit of retransmitting it again since by the time it is retransmitted the person may have already looked down and therefore no longer expects to see the ceiling. Recognising the nature of pose/control UL transmissions for services like XR, proposals have been made that such UL transmissions do not require HARQ retransmissions and, since they are small, they can be transmitted with very robust (i.e. low) MCSs thereby ensuring their reliability [10]. In addition, retransmission-less CG-PUSCH also has the benefits of both resource saving, since resources are not required to be used for retransmissions, and power saving, since the UE does not have to monitor for a potential retransmission from the gNB.

In [10], it is proposed that the configuredGrantTimer (T_{CG-ACK}) described above following discussion of FIG. 8 is set to zero for the main CG-PUSCH. That is, the UE times out the retransmission and flushes its HARQ buffer immediately after transmitting the main CG-PUSCH. In the current 3GPP system however, the minimum value of configuredGrantTimer is equal to one CG-PUSCH period. Hence, the current specifications do not allow a configuration where configuredGrantTimer=0. Introducing the value 0 to configuredGrantTimer would therefore have backward compatibility issues since legacy UEs may not understand the new value.

In other applications, such as in a non-terrestrial network (NTN) system, the round-trip time (RTT) is very long and hence, in some operations, HARQ retransmissions are not practical since the UE has to wait a significant amount of time for an acknowledgement before it can flush its HARQ buffer.

Recognising this, HARQ Mode B is introduced in NTN where for a configured set of HARQ Process Number (HPN), HARQ retransmission is disabled. It is proposed in that HARQ Mode B is also supported in terrestrial networks (TNs), thereby allowing CG-PUSCH to operate without HARQ retransmission. However, HARQ Mode B is configured on a per-HPN basis; that is, whether HARQ retransmission is used or not depends on the HPN of the PUSCH. This may be acceptable for dynamic PUSCH where the HPN is indicated by the gNB, but for CG-PUSCH the HPN is calculated depending upon the starting symbol of the CG-PUSCH transmission occasion and its periodicity, which is not easily controlled by the gNB or the UE, and so HARQ Mode B is not suitable for CG-PUSCH operation.

Hence, a technical problem to solve is to provide a mechanism to enable HARQ retransmission-less communications, for example for CG-PUSCH, and particularly for time-sensitive applications such as XR. Embodiments of the present technique seek to provide solutions to such a problem.

### Retransmission-less Indicator

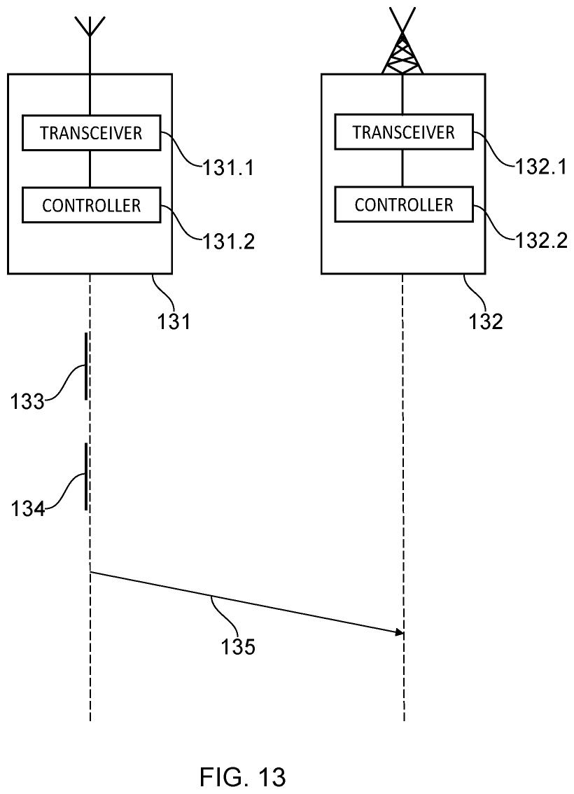

FIG. 13 shows a part schematic, part message flow diagram representation of a first wireless communications system comprising a communications device 131 (e.g. a UE 14) and an infrastructure equipment 132 (e.g. a gNB 10) in accordance with at least some embodiments of the present technique.

The communications device 131 is configured to transmit signals to and/or receive signals from the wireless communications network, for example, to and from the infrastructure equipment 132.

Specifically, the communications device 131 may be configured to transmit data to and/or receive data from the wireless communications network (e.g. to/from the infrastructure equipment 132) via a wireless radio interface provided by the wireless communications network (e.g., a Uu interface between the communications device 131 and the Radio Access Network (RAN), which includes the infrastructure equipment 132). Such data transmitted by the communications device 131 may, for example, include data for applications such as XR. The communications device 131 and the infrastructure equipment 132 each comprise a transceiver (or transceiver circuitry) 131.1, 132.1, and a controller (or controller circuitry) 131.2, 132.2. Each of the controllers 131.2, 132.2 may be, for example, a microprocessor, a CPU, or a dedicated chipset, etc.

As shown in the example of FIG. 13, the transceiver circuitry 131.1 and the controller circuitry 131.2 of the communications device 131 are configured in combination to determine 133 that the communications device 131 has uplink data to transmit to the wireless communications network (e.g. to the infrastructure equipment 132), to select 134 an uplink transmission occasion within a set of uplink resources of the wireless access interface to carry the uplink data to the wireless communications network (e.g. to the infrastructure equipment 132), wherein the communications device 131 is configured to select 134 the uplink transmission occasion based on a retransmission indicator associated with the selected uplink transmission occasion that indicates whether or not one or more retransmissions of an uplink channel are to be performed by the communications device 131 after an initial transmission of the uplink channel in the selected uplink transmission occasion, and to transmit 135 the uplink channel carrying the uplink data to the wireless communications network (e.g. to the infrastructure equipment 132) in accordance with the retransmission indicator. Here, the selected uplink transmission occasion may in fact be a selected one or more uplink transmission occasions (such as CG-PUSCH occasions within a period of the CG-PUSCH configuration) in order to support retransmissions, for example within a particular time window.

If the retransmission indicator indicates that the uplink transmission is retransmission-less, then the UE will not expect any uplink grants for performing retransmissions from the gNB, and so will not monitor for them (e.g. during DRX ON periods). In other words, the communications device may be configured to determine, if the retransmission indicator indicates that no retransmissions of the uplink channel are to be performed by the communications device after the initial transmission of the uplink channel, that the communications device is not to monitor for a retransmission resource grant from the wireless communications network. The UE will also not expect to receive (and so will not monitor for) any HARQ acknowledgement from the gNB if the retransmission indicator indicates that no retransmissions of the uplink channel are to be performed by the UE after the initial transmission of the uplink channel, because the gNB also knows that no retransmissions will be performed based on the retransmission indicator and hence such HARQ acknowledgements would not serve any purpose. In other words, if the retransmission indicator indicates that no retransmissions of the uplink channel are to be performed by the communications device after the initial transmission of the uplink channel, that the communications device is not to monitor for acknowledgement feedback for the transmitted uplink channel from the wireless communications network.

Essentially, such embodiments of the present technique as exemplified by FIG. 13 propose that a HARQ retransmission-less indicator (also referred interchangeably to herein as a retransmission indicator) be introduced, that indicates whether a transmission (e.g. an uplink transmission) is HARQ retransmission-less or whether it requires HARQ retransmission. In some arrangements of embodiments of the present technique, and as generally described in most of such arrangements below, this uplink transmission (i.e. carried by the uplink channel in the selected uplink transmission occasion as referred to in the example of FIG. 13) is a CG-PUSCH transmission. However, those skilled in the art would appreciate that embodiments of the present technique are applicable to other types of uplink transmission, and that the invention is not intended to be limited to application for CG-PUSCH transmissions.

In some arrangements of embodiments of the present technique, the said HARQ retransmission-less indicator is a new RRC parameter, which may for example be named “retransmission-less”. In other words, the communications device may be configured to receive the retransmission indicator from the wireless communications network within radio resource control, RRC, signalling. This new RRC parameter can be configured for each CG-PUSCH configuration, where this said new RRC parameter indicates whether a CG-PUSCH is HARQ retransmission-less or it requires HARQ retransmission.

Unlike the prior art where it proposed to add a new zero value to the existing RRC parameter configuredGrantTimer, such arrangements do not lead to backward compatibility issues, as they do not necessitate the reuse of an existing field. In other words, the retransmission indicator may be indicated by a dedicated field (e.g. “retransmission-less”) within the RRC signalling. Legacy UEs would operate with HARQ retransmissions in the uplink as normal even if the retransmission-less field is set to indicate that a particular transmission is retransmission-less, as such UEs do not understand the said new retransmission-less parameter. Correspondingly, in the downlink, such legacy UEs will just wait for retransmissions (that never come) as per legacy behaviour, but here a Rel-18 UE that is configured to operate in accordance with this new behaviour would know that there is no retransmission coming and therefore can perform other tasks or just go to sleep to save power. As described previously, there are a maximum of twelve CG-PUSCH configurations and, in such arrangements, the retransmission-less parameter can be independently configured for each of these CG-PUSCH. That is, the gNB can decide which CG-PUSCHs are HARQ retransmission-less and which require HARQ retransmissions.

In some arrangements of embodiments of the present technique, a new class of Logical Channels (LCHs) are introduced, where data under these LCHs does not requires HARQ retransmission. Such arrangements enable a UE to multiplex one or more Protocol Data Units (PDUs) from HARQ retransmission-less LCHs into a HARQ retransmission-less CG-PUSCH. It should be appreciated that in the legacy operation, UEs multiplex PDUs from multiple LCHs into a single PUSCH for transmission. In other words, the communications device may be configured to multiplex the uplink data from one or more logical channels of a predefined class of logical channels to the uplink channel, the uplink channel being mapped to the one or more logical channels, wherein data multiplexed to a transport channel (such as the uplink channel) from any logical channel of the predefined class of logical channels does not require retransmission by the communications device after an initial transmission of the transport channel.

Hence, by classifying a new HARQ retransmission-less LCH class, PDUs that require HARQ retransmission would not be multiplexed together with PDUs that do not require HARQ retransmission in a HARQ retransmission-less CG-PUSCH, since this would lead to all the PDUs in the CG-PUSCH to be denied HARQ retransmission. Such arrangements therefore provide a means for a UE to distinguish PDUs that do not require HARQ retransmission from those that do, and therefore would multiplex only PDUs that do not require HARQ retransmission into a HARQ retransmission-less CG-PUSCH. As those skilled in the art would appreciate, there can be more than one HARQ retransmission-less LCH. Such new LCH classes(es) could be fixed in the specifications and therefore known to the UE, or could be indicated (e.g. via semi static signalling) to UEs by the network (e.g. by gNBs).

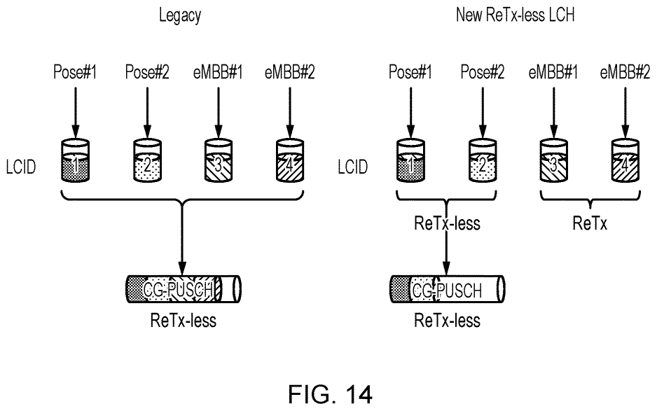

An example is shown in FIG. 14, where four LCHs with LCID 1, 2, 3 and 4 are shown. Pose data from an XR device, Pose #1 and Pose #2, arrive at a UE's buffer and they are mapped to LCID 1 and 2 respectively. In addition to pose data, eMBB data eMBB #1 and eMBB #2 also arrive at the UE's buffer and they are mapped to LCID 3 and 4 respectively. A HARQ retransmission-less CG-PUSCH is available to carry the data and in the legacy system, since the CG-PUSCH has sufficient payload to carry all the PDUs in LCID 1, 2, 3 and 4, all PDUs are multiplexed into a single CG-PUSCH and they are transmitted to the gNB. The legacy UE does not know that the CG-PUSCH is HARQ retransmission-less, and also cannot distinguish which PDUs require retransmission and which do not. If the gNB fails to decode the CG-PUSCH received from the legacy UE, then eMBB #1 and eMBB #2 would not be asked for a retransmission and the legacy UE will therefore have to rely on higher layer acknowledgements to retransmit eMBB #1 and eMBB #2 again. In contrast, by defining a new HARQ retransmission-less class (labelled as ReTx-less), to which LCID 1 and 2 belong and which distinguishes these LCHs from the two LCHs (i.e. LCID 3 and 4 to which the PDUs requiring HARQ retransmission are mapped) which do not belong to this new re-transmission-less class (labelled as ReTx), Rel-18 UEs, recognising that the CG-PUSCH is HARQ retransmission-less, would only multiplex PDUs from LCID 1 and 2 into the CG-PUSCH.

Those UEs would then use a different CG-PUSCH—i.e. one that requires HARQ retransmission—for PDUs mapped to LCID 3 and 4, to transmit the eMBB data appropriately.

In some arrangements of embodiments of the present technique, the said HARQ retransmission-less indicator is indicated in the activation DCI used for activating CG-PUSCH Type 2. In other words, the communications device may be configured to receive the retransmission indicator from the wireless communications network within an activation downlink control indication, DCI, wherein the activation DCI indicates that the CG-PUSCH is activated and is able to be used by the communications device to transmit signals to the wireless communications network. That is, a new field or reinterpretation of an existing field in the activation DCI is used to indicate whether the activated CG-PUSCH is HARQ retransmission-less or whether it requires HARQ retransmission. This enables flexibility for the gNB to decide at the point of activation whether a CG-PUSCH requires HARQ retransmission or not.

In some arrangements of embodiments of the present technique, if a (main) CG-PUSCH configuration is semi-statically configured or indicated by an activation DCI as HARQ retransmission-less, then all of its corresponding supplementary CG-PUSCHs are also HARQ retransmission-less. On the other hand, if a (main) CG-PUSCH configuration is semi-statically configured or indicated by an activation DCI as requiring HARQ retransmission, then all of its corresponding supplementary CG-PUSCHs require HARQ retransmissions. That is the network needs only to indicate whether the main CG-PUSCH is HARQ retransmission-less or requires HARQ retransmission and the supplementary CG-PUSCHs would just follow the configuration of the main CG-PUSCH. In other words, the CG-PUSCH may be a main CG-PUSCH which is associated with one or more supplementary CG-PUSCHs, and wherein the retransmission indicator is applicable to the main CG-PUSCH and the one or more supplementary CG-PUSCHs.

In some arrangements of embodiments of the present technique, if an entire multi-CG-PUSCH configuration, comprising of multiple main CG-PUSCHs and their associated supplementary CG-PUSCHs, is semi-statically configured or indicated by an activation DCI as HARQ retransmission-less, then that entire multi-CG-PUSCH configuration is retransmission-less. That is, the retransmission-less indicator applies to an entire multi-CG-PUSCH configuration. In other words, the CG-PUSCH may be one of a plurality of configured CG-PUSCHs in a periodic sequence (of main CG-PUSCH occasions and their supplementary CG-PUSCH occasions), and wherein the retransmission indicator is applicable to the plurality of configured CG-PUSCHs in that periodic sequence.

In some arrangements of embodiments of the present technique, the main CG-PUSCH and each of its supplementary CG-PUSCHs in one CG period may be independently configured to be HARQ retransmission-less or requiring HARQ retransmission. That is, for each CG-PUSCH configuration, the network can configure individually whether the main CG-PUSCH and one or more of its supplementary CG-PUSCHs are HARQ retransmission-less or require HARQ retransmission. For example, the network may configure two CG-PUSCH configurations where:
CG-PUSCH #1: Contains a main CG-PUSCH, i.e. CG-PUSCH #1-0, and two supplementary CG-PUSCHs, i.e., CG-PUSCH #1-1 and CG-PUSCH #1-2; and
CG-PUSCH #2: Contains a main CG-PUSCH, i.e., CG-PUSCH #2-0 and one supplementary CG-PUSCH, i.e. CG-PUSCH #2-1.

In this embodiment, the network can configure each individual CG-PUSCH, for example:
For CG-PUSCH #1:
   Main CG-PUSCH #1-0 and supplementary CG-PUSCH #1-2 require HARQ retransmission; and
   Supplementary CG-PUSCH #1-1 is HARQ retransmission-less;
For CG-PUSCH #2:
   Supplementary CG-PUSCH #2-1 requires HARQ retransmission; and
   Main CG-PUSCH #2-0 is HARQ retransmission-less.

The retransmission-less configuration for the main CG-PUSCH and each of its supplementary CG-PUSCHs can be RRC configured. In other words, the CG-PUSCH is a main CG-PUSCH which is associated with one or more supplementary CG-PUSCHs, and wherein a separate retransmission indicator is associated with each of the main CG-PUSCH and the one or more supplementary CG-PUSCHs. Here, these separate retransmission indicators may be received by the communications device via RRC signalling from the wireless communications network.

The retransmission-less configuration for the main CG-PUSCH and each of its supplementary CG-PUSCHs can be indicated in the activation DCI where the activation DCI indicates the HARQ retransmission-less requirement for the main CG-PUSCH and each of its supplementary CG-PUSCH individually. In other words, here, the communications device may be configured to receive the separate retransmission indicators as described above from the wireless communications network within an activation downlink control indication, DCI, wherein the activation DCI indicates that the main CG-PUSCH is activated and is able to be used by the communications device to transmit signals to the wireless communications network.

An example implementation where the retransmission-less indicator is indicated in the activation DCI may be to have a new field consisting of a bitmap where “1” means retransmission-less and “0” means requires HARQ retransmission. For example, if the activation DCI activates a CG-PUSCH consisting of a main CG-PUSCH #1-0 and three supplementary CG-PUSCH, CG-PUSCH #1-1, CG-PUSCH #1-2 and CG-PUSCH #1-3, a 4-bit bitmap can be used. In this example, if the bitmap is {0110}, this means that the main CG-PUSCH #1-0 and supplementary CG-PUSCH #1-3 require HARQ retransmissions, whilst supplementary CG-PUSCH #1-1 and supplementary CG-PUSCH #1-2 are HARQ retransmission-less.

In some arrangements of embodiments of the present technique, the said HARQ retransmission-less indicator is in the UCI (e.g., CG-UCI) associated with (or indeed within) a CG-PUSCH. In other words, the communications device may be configured to transmit the retransmission indicator to the wireless communications network within uplink control information, UCI, where here the uplink channel is a configured grant of physical uplink shared channel, CG-PUSCH, and wherein the UCI may be transmitted within the CG-PUSCH. That is the UCI contains a field, which can be a new field or reinterpretation of an existing field, that indicates whether the CG-PUSCH is HARQ retransmission-less or requires HARQ retransmission. This enables the UE to indicate on a per-CG-PUSCH occasion basis whether that CG-PUSCH transmission requires HARQ retransmission or not which provides flexibility for the UE. It would be appreciated by those skilled in the art that this new indicator can be used in the CG-UCI for NR-U CG-PUSCH and the CG-UCI in CG-PUSCH with supplementary CG-PUSCHs.

Furthermore, the said HARQ retransmission-less indicator in CG-UCI of a CG-PUSCH can be applied to one or both of the CG-PUSCH types (i.e., Type-1 or Type 2).

In some other arrangements of embodiments of the present technique, for a CG-PUSCH occasion, if the retransmission-less indicator in the CG-UCI indicates that the main CG-PUSCH in that occasion is retransmission-less, then the corresponding supplementary CG-PUSCHs of that main CG-PUSCH in that CG-PUSCH occasion are also HARQ retransmission-less. In other words, for a CG-PUSCH occasion consisting of a main CG-PUSCH and with associated one or more supplementary CG-PUSCHs, the retransmission indicator is applicable to the main CG-PUSCH and all of the one or more supplementary CG-PUSCHs.

In some arrangements of embodiments of the present technique, the CG-UCI (i.e. in a main CG-PUSCH) used to activate one or more supplementary CG-PUSCH can indicate whether one or more supplementary CG-PUSCH is HARQ retransmission-less or requires HARQ retransmission. In other words, the UCI may comprise an activation indication indicating that one or more supplementary CG-PUSCHs associated with the CG-PUSCH are activated and will be used by the communications device to transmit signals to the wireless communications network, and wherein the UCI comprises a separate retransmission indicator for each of the one or more supplementary CG-PUSCHs.

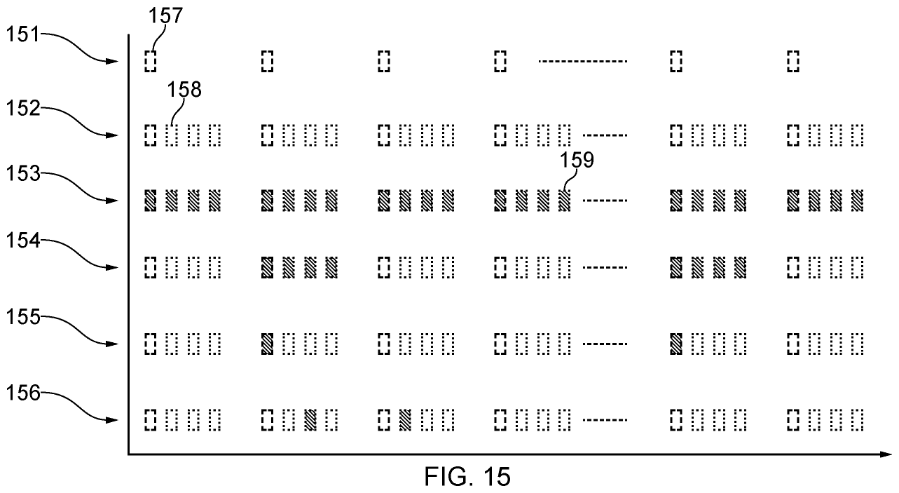

Various examples of the newly defined HARQ retransmission-less indicator as described herein are illustrated in FIG. 15, which illustrates six different schemes; the bottom four of which are examples of operation defined herein in accordance with arrangements of embodiments of the present technique. The top scheme 151 is an illustration of the legacy scheme, such as 3GPP Rel-17 CG-PUSCH, in which a single CG-PUSCH transmission 157 is periodically configured, which is illustrated in the examples of FIG. 15 has having dashed lines. In the on-going 3GPP Rel-18 standard, as described above, the introduction of a multi CG-PUSCH configuration is currently being discussed, and this is shown in the second-top scheme 152. Here, each main CG-PUSCH 157 as configured in the sequence in the same manner as in the legacy scheme 151 is associated with one or more (and in the examples shown in FIG. 15, three) supplementary CG-PUSCHs 158, which are illustrated in the examples of FIG. 15 as having dotted lines.

FIG. 15 illustrates some examples 153, 154, 155, 156 of implementing various examples of the HARQ retransmission-less indicator as described herein in multi CG-PUSCH operation.

The first scheme 153 of these four schemes illustrates an example where all PUSCH occasions are operated in accordance with the HARQ retransmission-less behaviour, where such retransmission-less CG-PUSCH occasions are illustrated in the examples of FIG. 15 as being shaded. The HARQ retransmission-less status here can be configured via any suitable method as described above, for example via RRC signalling or via activation DCI where the main CG-PUSCH is indicated as HARQ retransmission-less and the supplementary CG-PUSCHs follow the configuration of the main CG-PUSCH.

The second scheme 154 of these four schemes illustrates an example where one or some of the multi CG-PUSCHs occasions in the overall sequence are operated with HARQ retransmission-less, with each instance of main and supplementary CG-PUSCHs in the sequence being indicated as retransmission-less or requiring retransmission together. For example, this can be implemented using CG-UCI as described above to indicate the main CG-PUSCH as HARQ retransmission-less and its associated one or more supplementary CG-PUSCH follows the configuration of the main CG-PUSCH.

The third scheme 155 of these four schemes illustrates an example where one or some of the main CG-PUSCH occasions in a multi CG-PUSCH configuration are operated in accordance with HARQ retransmission-less behaviour. This can be implemented by having CG-UCI as described above to indicate individually which of the main CG-PUSCH and/or supplementary CG-PUSCH are HARQ retransmission-less. In this example, only main CG-PUSCHs are operated in accordance with the HARQ retransmission-less behaviour, but those skilled in the art would appreciate that the CG-UCI may indicate one or more supplementary CG-PUSCHs may also be retransmission-less in addition to the indicated one or more main CG-PUSCHs.

The fourth scheme 156 of these four schemes illustrates an example where one or some of the supplementary CG-PUSCH occasions in a multi CG-PUSCH configuration are operated in accordance with HARQ retransmission-less behaviour. This can be implemented by having CG-UCI as described above to indicate individually which of the main CG-PUSCH and/or supplementary CG-PUSCH are HARQ retransmission-less. In this example, only supplementary CG-PUSCHs are operated in accordance with the HARQ retransmission-less behaviour, but those skilled in the art would appreciate that the CG-UCI may indicate one or more main CG-PUSCHs may also be retransmission-less in addition to the indicated one or more supplementary CG-PUSCHs.

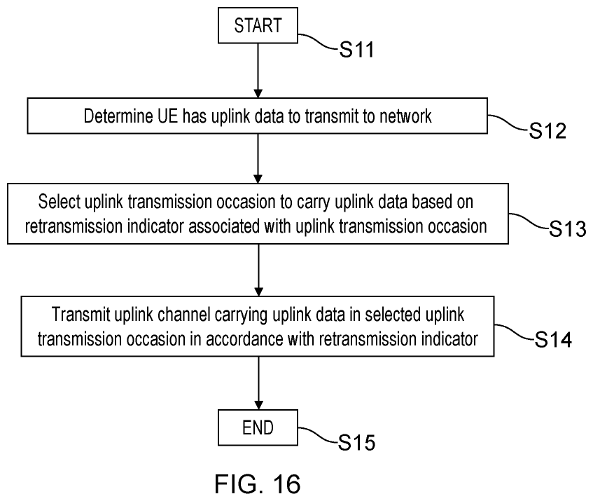

FIG. 16 shows a flow diagram illustrating a first example process of communications in a communications system in accordance with embodiments of the present technique. The process shown by FIG. 16 is specifically a method of operating a communications device (e.g. UE) configured to transmit signals to and/or to receive signals from a wireless communications network via a wireless access interface.

The method begins in step S11. The method comprises, in step S12, determining that the communications device has uplink data to transmit to the wireless communications network. In step S13, the process comprises selecting an uplink transmission occasion within a set of uplink resources of the wireless access interface to carry the uplink data to the wireless communications network, wherein the communications device selects the uplink transmission occasion based on a retransmission indicator associated with the selected uplink transmission occasion that indicates whether or not one or more retransmissions of tan uplink channel are to be performed by the communications device after an initial transmission of the uplink channel in the selected uplink transmission occasion. Then, in step S14, the method comprises transmitting the uplink channel carrying the uplink data to the wireless communications network in accordance with the retransmission indicator. The process ends in step S15.

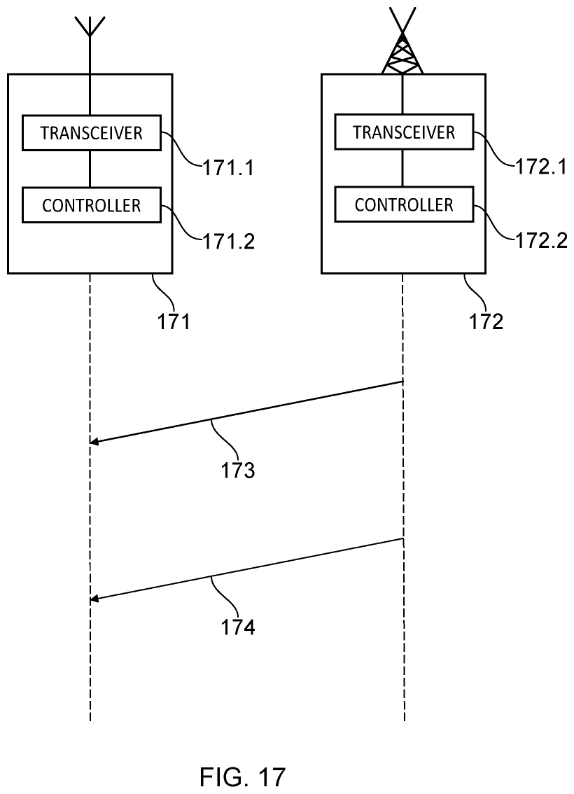

FIG. 17 shows a part schematic, part message flow diagram representation of a first wireless communications system comprising a communications device 171 (e.g., a UE 14) and an infrastructure equipment 172 (e.g., a gNB 10) in accordance with at least some embodiments of the present technique.

The communications device 171 is configured to transmit signals to and/or receive signals from the wireless communications network, for example, to and from the infrastructure equipment 172.

Specifically, the communications device 171 may be configured to transmit data to and/or receive data from the wireless communications network (e.g., to/from the infrastructure equipment 172) via a wireless radio interface provided by the wireless communications network (e.g., a Uu interface between the communications device 171 and the Radio Access Network (RAN), which includes the infrastructure equipment 172). Such data transmitted by the communications device 171 may, for example, include data for applications such as XR. The communications device 171 and the infrastructure equipment 172 each comprise a transceiver (or transceiver circuitry) 171.1, 172.1, and a controller (or controller circuitry) 171.2, 172.2. Each of the controllers 171.2, 172.2 may be, for example, a microprocessor, a CPU, or a dedicated chipset, etc.

As shown in the example of FIG. 17, the transceiver circuitry 171.1 and the controller circuitry 171.2 of the communications device 171 are configured in combination to receive 173, from the wireless communications network (e.g. from the infrastructure equipment 172), a retransmission indicator associated with a downlink transmission occasion that indicates whether or not one or more retransmissions of a downlink channel to be received by the communications device 171 in the downlink transmission occasion within a set of downlink resources of the wireless access interface from the wireless communications network (e.g. from the infrastructure equipment 172) may be performed by the wireless communications network (e.g. by the infrastructure equipment 172) after an initial transmission of the downlink channel, and to receive 174 the downlink channel from the wireless communications network (e.g. from the infrastructure equipment 172) in accordance with the retransmission indicator, wherein the downlink channel comprises downlink data. Here, and indeed in all arrangements of embodiments of the present technique as described herein, those skilled in the art would appreciate that even if the retransmission indicator indicates that retransmissions should be performed, this does not necessarily mean that they will be. For example, if the channel conditions are good enough, in the example of FIG. 17, the wireless communications network (e.g. the infrastructure equipment 172) may determine that retransmission is not necessary. However, in such an example, since the retransmission indicator indicates that retransmissions may be performed, the communications device 171 will still be required to monitor for such retransmissions (unless specifically instructed otherwise), particularly when communications device 171 could not successfully decode the earlier transmission.

Essentially, such embodiments of the present technique as exemplified by FIG. 17 propose that a HARQ retransmission-less indicator be introduced for downlink transmissions. That is, while many of the arrangements of embodiments of the present technique as described above, with reference to FIGS. 13 to 16 for example, are targeted at uplink transmissions, and CG-PUSCH transmissions in particular, such embodiments of the present technique as exemplified by FIG. 17 propose that a HARQ retransmission-less indicator be introduced that indicates whether a downlink transmission (e.g. a PDSCH or SPS PDSCH) is HARQ retransmission-less or whether it requires HARQ retransmission.

If the retransmission indicator indicates that the downlink transmission is retransmission-less, then the UE will not expect any retransmissions from the gNB, and so will not monitor for them (e.g. during DRX ON periods). In other words, the communications device may be configured to determine, if the retransmission indicator indicates that no retransmissions of the downlink channel are to be performed by the wireless communications network after the initial transmission of the downlink channel, that the communications device may not be configured to monitor for retransmissions of the downlink channel from the wireless communications network. The UE may also not be required to transmit a HARQ acknowledgement to the gNB if the retransmission indicator indicates that no retransmissions of the downlink channel are to be performed by the gNB after the initial transmission of the downlink channel, since such HARQ acknowledgements would not serve a useful purpose if they did not prompt a retransmission in cases where the initial transmission was not successfully received. In other words, if the retransmission indicator indicates that no retransmissions of the downlink channel are to be performed by the wireless communications network after the initial transmission of the downlink channel, that the communications device may not be configured to transmit any acknowledgement feedback for the downlink channel to the wireless communications network.

In some arrangements of embodiments of the present technique, each SPS (or indeed non-SPS PDSCH) can be RRC configured, independently, to be HARQ retransmission-less or to require HARQ retransmission. In other words, the retransmission indicator may be received from the wireless communications network within radio resource control, RRC, signalling. Those skilled in the art would then understand that the SPS instances (or PDSCHs) that are configured to be HARQ retransmission-less would not have any associated PUCCH resource, since the UE does not need to transmit a HARQ-ACK in a PUCCH as it would not have any impact given that the SPS/PDSCH would not be retransmitted even if a NACK were transmitted. Here, this retransmission indicator may be indicated by a dedicated field within the RRC signalling.

In some arrangements of embodiments of the present technique, the activation DCI of an SPS indicates whether that SPS is HARQ retransmission-less or requires HARQ retransmission. In other words, the communications device may be configured to receive the retransmission indicator from the wireless communications network within an activation downlink control indication, DCI, wherein the activation DCI indicates that the SPS-PDSCH is activated and is to be monitored by the communications device for signals transmitted by the wireless communications network.

In some arrangements of embodiments of the present technique, the DL Grant of a PDSCH indicates whether the PDSCH is HARQ retransmission-less or requires HARQ retransmission. In other words, the communications device may be configured to receive the retransmission indicator from the wireless communications network within downlink control indication, DCI, comprising a downlink grant scheduling the set of downlink resources for the communications device to receive the downlink channel from the wireless communications network.

In some arrangements of embodiments of the present technique, a control information embedded in the PDSCH (such as a Medium Access Control (MAC) control element (CE)) indicates whether the PDSCH is HARQ retransmission-less or requires HARQ retransmission. In other words, the downlink channel received from the wireless communications network may comprise control information, and wherein the control information comprises the retransmission indicator.

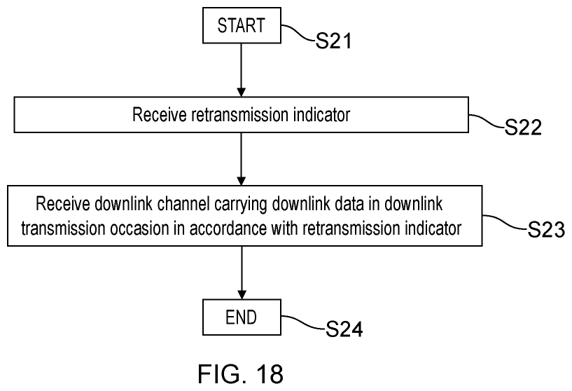

FIG. 18 shows a flow diagram illustrating a first example process of communications in a communications system in accordance with embodiments of the present technique. The process shown by FIG. 18 is specifically a method of operating a communications device (e.g. UE) configured to transmit signals to and/or to receive signals from a wireless communications network via a wireless access interface.

The method begins in step S21. The method comprises, in step S22, receiving, from the wireless communications network, a retransmission indicator associated with a downlink transmission occasion that indicates whether or not one or more retransmissions of a downlink channel to be received by the communications device in the downlink transmission occasion within a set of downlink resources of the wireless access interface from the wireless communications network may be performed by the wireless communications network after an initial transmission of the downlink channel. In step S23, the process comprises receiving the downlink channel from the wireless communications network in accordance with the retransmission indicator, wherein the downlink channel comprises downlink data. The process ends in step S24.

Those skilled in the art would appreciate that the methods shown by FIGS. 16 and 18 may be adapted in accordance with embodiments of the present technique. For example, other intermediate steps may be included in such methods, or the steps may be performed in any logical order. Though embodiments of the present technique have been described largely by way of the example communications systems shown in FIGS. 13 and 17, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:
Paragraph 1. A method of operating a communications device configured to transmit signals to and/or to receive signals from a wireless communications network via a wireless access interface, the method comprising
   determining that the communications device has uplink data to transmit to the wireless communications network,
   selecting an uplink transmission occasion within a set of uplink resources of the wireless access interface to carry the uplink data to the wireless communications network, wherein the communications device selects the uplink transmission occasion based on a retransmission indicator associated with the selected uplink transmission occasion that indicates whether or not one or more retransmissions of an uplink channel are to be performed by the communications device after an initial transmission of the uplink channel in the selected uplink transmission occasion, and
   transmitting the uplink channel carrying the uplink data to the wireless communications network in accordance with the retransmission indicator.
Paragraph 2. A method according to Paragraph 1, comprising
   receiving the retransmission indicator from the wireless communications network within radio resource control, RRC, signalling.
Paragraph 3. A method according to Paragraph 2, wherein the retransmission indicator is indicated by a dedicated field within the RRC signalling.
Paragraph 4. A method according to any of Paragraphs 1 to 3, wherein the uplink channel is a configured grant of physical uplink shared channel, CG-PUSCH.
Paragraph 5. A method according to any of Paragraphs 1 to 4, wherein the selected uplink transmission occasion comprises one or more configured grant of physical uplink shared channel, CG-PUSCH, transmission occasions within a period of the CG-PUSCH configuration.
Paragraph 6. A method according to Paragraph 4 or Paragraph 5, comprising
   receiving the retransmission indicator from the wireless communications network within an activation downlink control indication, DCI, wherein the activation DCI indicates that the CG-PUSCH is activated and is able to be used by the communications device to transmit signals to the wireless communications network.
Paragraph 7. A method according to any of Paragraphs 4 to 6, wherein the CG-PUSCH is one of a plurality of configured CG-PUSCHs in a periodic sequence, and wherein the retransmission indicator is applicable to all of the plurality of configured CG-PUSCHs in the periodic sequence.
Paragraph 8. A method according to any of Paragraphs 4 to 7, wherein the CG-PUSCH is a main CG-PUSCH which is associated with one or more supplementary CG-PUSCHs, and wherein the retransmission indicator is applicable to all of the main CG-PUSCH and the one or more supplementary CG-PUSCHs.
Paragraph 9. A method according to any of Paragraphs 4 to 8, wherein the CG-PUSCH is a main CG-PUSCH which is associated with one or more supplementary CG-PUSCHs, and wherein the retransmission indicator is applicable to only the main CG-PUSCH and not with any of the one or more supplementary CG-PUSCHs.
Paragraph 10. A method according to Paragraph 9, comprising
   receiving the retransmission indicator from the wireless communications network within an activation downlink control indication, DCI, wherein the activation DCI indicates that the main CG-PUSCH is activated and is able to be used by the communications device to transmit signals to the wireless communications network, and
   receiving, from the wireless communications network within the activation DCI, a separate retransmission indicator for each of the one or more supplementary CG-PUSCHs.

Paragraph 11. A method according to Paragraph 9, comprising
receiving, from the wireless communications network via RRC signalling, a separate retransmission indicator for each of the main CG-PUSCH and the one or more supplementary CG-PUSCHs.

Paragraph 12. A method according to any of Paragraphs 1 to 11, comprising
transmitting the retransmission indicator to the wireless communications network within uplink control information, UCI.
Paragraph 13. A method according to Paragraph 12, wherein the uplink channel is a configured grant of physical uplink shared channel, CG-PUSCH, and wherein the UCI is transmitted within the CG-PUSCH.
Paragraph 14. A method according to Paragraph 13, wherein the UCI comprises an activation indication indicating that one or more supplementary CG-PUSCHs associated with the CG-PUSCH are activated and will be used by the communications device to transmit signals to the wireless communications network, and wherein the UCI comprises a single retransmission indicator for all of the main CG-PUSCH and the one or more supplementary CG-PUSCHs.
Paragraph 15. A method according to Paragraph 13, wherein the UCI comprises an activation indication indicating that one or more supplementary CG-PUSCHs associated with the CG-PUSCH are activated and will be used by the communications device to transmit signals to the wireless communications network, and wherein the UCI comprises a separate retransmission indicator for the main CG-PUSCH and for each of the one or more supplementary CG-PUSCHs.
Paragraph 16. A method according to any of Paragraphs 1 to 15, comprising
   multiplexing the uplink data from one or more logical channels of a predefined class of logical channels to the uplink channel, the uplink channel being mapped to the one or more logical channels, wherein data multiplexed to a transport channel from any logical channel of the predefined class of logical channels does not require retransmission by the communications device after an initial transmission of the transport channel.
Paragraph 17. A method according to any of Paragraphs 1 to 16, comprising
   determining, if the retransmission indicator indicates that no retransmissions of the uplink channel are to be performed by the communications device after the initial transmission of the uplink channel, that the communications device is not to monitor for a retransmission resource grant from the wireless communications network.
Paragraph 18. A method according to any of Paragraphs 1 to 17, comprising
   determining, if the retransmission indicator indicates that no retransmissions of the uplink channel are to be performed by the communications device after the initial transmission of the uplink channel, that the communications device is not to monitor for acknowledgement feedback for the transmitted uplink channel from the wireless communications network.
Paragraph 19. A communications device comprising
   transceiver circuitry configured to transmit signals to and/or to receive signals from a wireless communications network via a wireless access interface, and
   controller circuitry configured in combination with the transceiver circuitry
   to determine that the communications device has uplink data to transmit to the wireless communications network,
   to select an uplink transmission occasion within a set of uplink resources of the wireless access interface to carry the uplink data to the wireless communications network, wherein the communications device is configured to select the uplink transmission occasion based on a retransmission indicator associated with the selected uplink transmission occasion that indicates whether or not one or more retransmissions of an uplink channel are to be performed by the communications device after an initial transmission of the uplink channel in the selected uplink transmission occasion, and
   to transmit the uplink channel carrying the uplink data to the wireless communications network in accordance with the retransmission indicator.
Paragraph 20. Circuitry for a communications device comprising
   transceiver circuitry configured to transmit signals to and/or to receive signals from a wireless communications network via a wireless access interface, and
   controller circuitry configured in combination with the transceiver circuitry
   to determine that the communications device has uplink data to transmit to the wireless communications network,
   to select an uplink transmission occasion within a set of uplink resources of the wireless access interface to carry the uplink data to the wireless communications network, wherein the communications device is configured to select the uplink transmission occasion based on a retransmission indicator associated with the selected uplink transmission occasion that indicates whether or not one or more retransmissions of an uplink channel are to be performed by the communications device after an initial transmission of the uplink channel in the selected uplink transmission occasion, and
   to transmit the uplink channel carrying the uplink data to the wireless communications network in accordance with the retransmission indicator.
Paragraph 21. A method of operating an infrastructure equipment forming part of a wireless communications network configured to transmit signals to and/or to receive signals from a communications device via a wireless access interface, the method comprising
   receiving an initial transmission of an uplink channel from the communications device, wherein the uplink channel comprises uplink data, and
   determining, based on a retransmission indicator associated with an uplink transmission occasion in which the uplink channel was received from the communications device, whether or not one or more retransmissions of the uplink channel are to be received by the infrastructure equipment from the communications device after the initial transmission of the uplink channel.
Paragraph 22. A method according to Paragraph 21, comprising
   transmitting the retransmission indicator to the communications device within radio resource control, RRC, signalling.
Paragraph 23. A method according to Paragraph 22, wherein the retransmission indicator is indicated by a dedicated field within the RRC signalling.
Paragraph 24. A method according to any of Paragraphs 21 to 23, wherein the uplink channel is a configured grant of physical uplink shared channel, CG-PUSCH.
Paragraph 25. A method according to any of Paragraphs 21 to 24, wherein the uplink transmission occasion comprises one or more configured grant of physical uplink shared channel, CG-PUSCH, transmission occasions within a period of the CG-PUSCH configuration.
Paragraph 26. A method according to Paragraph 24 or Paragraph 25, comprising
   transmitting the retransmission indicator to the communications device within an activation downlink control indication, DCI, wherein the activation DCI indicates that the CG-PUSCH is activated and is able to be used by the communications device to transmit signals to the wireless communications network.
Paragraph 27. A method according to any of Paragraphs 24 to 26, wherein the CG-PUSCH is one of a plurality of configured CG-PUSCHs in a periodic sequence, and wherein the retransmission indicator is applicable to all of the plurality of configured CG-PUSCHs in the periodic sequence.
Paragraph 28. A method according to any of Paragraphs 24 to 27, wherein the CG-PUSCH is a main CG-PUSCH which is associated with one or more supplementary CG-PUSCHs, and wherein the retransmission indicator is applicable to all of the main CG-PUSCH and the one or more supplementary CG-PUSCHs.
Paragraph 29. A method according to any of Paragraphs 24 to 28, wherein the CG-PUSCH is a main CG-PUSCH which is associated with one or more supplementary CG-PUSCHs, and wherein the retransmission indicator is applicable to only the main CG-PUSCH and not with any of the one or more supplementary CG-PUSCHs.
Paragraph 30. A method according to Paragraph 29, comprising
   transmitting the retransmission indicator to the communications device within an activation downlink control indication, DCI, wherein the activation DCI indicates that the main CG-PUSCH is activated and is able to be used by the communications device to transmit signals to the wireless communications network, and
   transmitting, to the communications device within the activation DCI, a separate retransmission indicator for each of the one or more supplementary CG-PUSCHs.
Paragraph 31. A method according to Paragraph 29, comprising
   transmitting, to the communications device via RRC signalling, a separate retransmission indicator for each of the main CG-PUSCH and the one or more supplementary CG-PUSCHs.
Paragraph 32. A method according to any of Paragraphs 21 to 31, comprising
   receiving the retransmission indicator from the communications device within uplink control information, UCI.
Paragraph 33. A method according to Paragraph 32, wherein the uplink channel is a configured grant of physical uplink shared channel, CG-PUSCH, and wherein the UCI is received within the CG-PUSCH.
Paragraph 34. A method according to Paragraph 33, wherein the UCI comprises an activation indication indicating that one or more supplementary CG-PUSCHs associated with the CG-PUSCH are activated and will be used by the communications device to transmit signals to the wireless communications network, and wherein the UCI comprises a single retransmission indicator for all of the main CG-PUSCH and the one or more supplementary CG-PUSCHs.
Paragraph 35. A method according to Paragraph 33, wherein the UCI comprises an activation indication indicating that one or more supplementary CG-PUSCHs associated with the CG-PUSCH are activated and will be used by the communications device to transmit signals to the wireless communications network, and wherein the UCI comprises a separate retransmission indicator for the main CG-PUSCH and for each of the one or more supplementary CG-PUSCHs.
Paragraph 36. A method according to any of Paragraphs 21 to 35, comprising
   transmitting, to the communications device, an indication of a predefined class of logical channels,
   wherein data multiplexed to a transport channel from any logical channel of the predefined class of logical channels does not require retransmission by the communications device after an initial transmission of the transport channel.
Paragraph 37. An infrastructure equipment forming part of a wireless communications network, the infrastructure equipment comprising
   transceiver circuitry configured to transmit signals to and/or to receive signals from a communications device via a wireless access interface, and
   controller circuitry configured in combination with the transceiver circuitry
   to receive an initial transmission of an uplink channel from the communications device, wherein the uplink channel comprises uplink data, and
   to determine, based on a retransmission indicator associated with an uplink transmission occasion in which the uplink channel was received from the communications device, whether or not one or more retransmissions of the uplink channel are to be received by the infrastructure equipment from the communications device after the initial transmission of the uplink channel.
Paragraph 38. Circuitry for an infrastructure equipment forming part of a wireless communications network, the infrastructure equipment comprising
   transceiver circuitry configured to transmit signals to and/or to receive signals from a communications device via a wireless access interface, and
   controller circuitry configured in combination with the transceiver circuitry
   to receive an initial transmission of an uplink channel from the communications device, wherein the uplink channel comprises uplink data, and
   to determine, based on a retransmission indicator associated with an uplink transmission occasion in which the uplink channel was received from the communications device, whether or not one or more retransmissions of the uplink channel are to be received by the infrastructure equipment from the communications device after the initial transmission of the uplink channel.
Paragraph 39. A wireless communications system comprising a communications device according to Paragraph 19 and an infrastructure equipment according to Paragraph 37.
Paragraph 40. A method of operating a communications device configured to transmit signals to and/or to receive signals from a wireless communications network via a wireless access interface, the method comprising
   receiving, from the wireless communications network, a retransmission indicator associated with a downlink transmission occasion that indicates whether or not one or more retransmissions of a downlink channel to be received by the communications device in the downlink transmission occasion within a set of downlink resources of the wireless access interface from the wireless communications network may be performed by the wireless communications network after an initial transmission of the downlink channel, and
   receiving the downlink channel from the wireless communications network in accordance with the retransmission indicator, wherein the downlink channel comprises downlink data.
Paragraph 41. A method according to Paragraph 40, wherein the retransmission indicator is received from the wireless communications network within radio resource control, RRC, signalling.
Paragraph 42. A method according to Paragraph 41, wherein the retransmission indicator is indicated by a dedicated field within the RRC signalling.
Paragraph 43. A method according to any of Paragraphs 40 to 42, wherein the downlink channel is a semi-persistent scheduling of physical downlink shared channel, SPS-PDSCH.
Paragraph 44. A method according to Paragraph 43, comprising
   receiving the retransmission indicator from the wireless communications network within an activation downlink control indication, DCI, wherein the activation DCI indicates that the SPS-PDSCH is activated and is to be monitored by the communications device for signals transmitted by the wireless communications network.
Paragraph 45. A method according to any of Paragraphs 40 to 44, comprising
   receiving the retransmission indicator from the wireless communications network within downlink control indication, DCI, comprising a downlink grant scheduling the set of downlink resources for the communications device to receive the downlink channel from the wireless communications network.
Paragraph 46. A method according to any of Paragraphs 40 to 45, wherein the downlink channel received from the wireless communications network comprises control information, and wherein the control information comprises the retransmission indicator.
Paragraph 47. A method according to any of Paragraphs 40 to 46, comprising
   determining, if the retransmission indicator indicates that no retransmissions of the downlink channel are to be performed by the wireless communications network after the initial transmission of the downlink channel, that the communications device is not to monitor for retransmissions of the downlink channel from the wireless communications network.
Paragraph 48. A method according to any of Paragraphs 40 to 47, comprising
   determining, if the retransmission indicator indicates that no retransmissions of the downlink channel are to be performed by the wireless communications network after the initial transmission of the downlink channel, that the communications device is not to transmit any acknowledgement feedback for the downlink channel to the wireless communications network.
Paragraph 49. A communications device comprising
   transceiver circuitry configured to transmit signals to and/or to receive signals from a wireless communications network via a wireless access interface, and
   controller circuitry configured in combination with the transceiver circuitry
   to receive, from the wireless communications network, a retransmission indicator associated with a downlink transmission occasion that indicates whether or not one or more retransmissions of a downlink channel to be received by the communications device in the downlink transmission occasion within a set of downlink resources of the wireless access interface from the wireless communications network may be performed by the wireless communications network after an initial transmission of the downlink channel, and
   to receive the downlink channel from the wireless communications network in accordance with the retransmission indicator, wherein the downlink channel comprises downlink data.
Paragraph 50. Circuitry for a communications device comprising
   transceiver circuitry configured to transmit signals to and/or to receive signals from a wireless communications network via a wireless access interface, and
   controller circuitry configured in combination with the transceiver circuitry
   to receive, from the wireless communications network, a retransmission indicator associated with a downlink transmission occasion that indicates whether or not one or more retransmissions of a downlink channel to be received by the communications device in the downlink transmission occasion within a set of downlink resources of the wireless access interface from the wireless communications network may be performed by the wireless communications network after an initial transmission of the downlink channel, and
   to receive the downlink channel from the wireless communications network in accordance with the retransmission indicator, wherein the downlink channel comprises downlink data.
Paragraph 51. A method of operating an infrastructure equipment forming part of a wireless communications network configured to transmit signals to and/or to receive signals from a communications device via a wireless access interface, the method comprising
   determining that the infrastructure equipment has downlink data to transmit to the communications device,
   selecting a downlink transmission occasion within a set of downlink resources of the wireless access interface to carry the downlink data to the communications device,
   transmitting, to the communications device, a retransmission indicator that indicates whether or not one or more retransmissions of a downlink may be performed by the infrastructure equipment after an initial transmission of the downlink channel in the selected downlink transmission occasion, and
   transmitting the downlink channel carrying the downlink data to the communications device in accordance with the retransmission indicator.
Paragraph 52. A method according to Paragraph 51, wherein the retransmission indicator is transmitted to the communications device within radio resource control, RRC, signalling.
Paragraph 53. A method according to Paragraph 52, wherein the retransmission indicator is indicated by a dedicated field within the RRC signalling.
Paragraph 54. A method according to any of Paragraphs 51 to 53, wherein the downlink channel is a semi-persistent scheduling of physical downlink shared channel, SPS-PDSCH.
Paragraph 55. A method according to Paragraph 54, comprising
   transmitting the retransmission indicator to the communications device within an activation downlink control indication, DCI, wherein the activation DCI indicates that the SPS-PDSCH is activated and is to be monitored by the communications device for signals transmitted by the infrastructure equipment.
Paragraph 56. A method according to any of Paragraphs 51 to 55, comprising
   transmitting the retransmission indicator to the communications device within downlink control indication, DCI, comprising a downlink grant scheduling the set of downlink resources for the infrastructure equipment to transmit the downlink channel to the communications device.
Paragraph 57. A method according to any of Paragraphs 51 to 56, wherein the downlink channel transmitted to the communications device comprises control information, and wherein the control information comprises the retransmission indicator.
Paragraph 58. An infrastructure equipment forming part of a wireless communications network, the infrastructure equipment comprising
   transceiver circuitry configured to transmit signals to and/or to receive signals from a communications device via a wireless access interface, and
   controller circuitry configured in combination with the transceiver circuitry
   to determine that the infrastructure equipment has downlink data to transmit to the communications device,
   to select a downlink transmission occasion within a set of downlink resources of the wireless access interface to carry the downlink data to the communications device,
   to transmit, to the communications device, a retransmission indicator that indicates whether or not one or more retransmissions of a downlink channel may be performed by the infrastructure equipment after an initial transmission of the downlink channel in the selected downlink transmission occasion, and
   to transmit the downlink channel carrying the downlink data to the communications device in accordance with the retransmission indicator.
Paragraph 59. Circuitry for an infrastructure equipment forming part of a wireless communications network, the infrastructure equipment comprising
   transceiver circuitry configured to transmit signals to and/or to receive signals from a communications device via a wireless access interface, and
   controller circuitry configured in combination with the transceiver circuitry
   to determine that the infrastructure equipment has downlink data to transmit to the communications device,
   to select a downlink transmission occasion within a set of downlink resources of the wireless access interface to carry the downlink data to the communications device,
   to transmit, to the communications device, a retransmission indicator that indicates whether or not one or more retransmissions of a downlink channel may be performed by the infrastructure equipment after an initial transmission of the downlink channel in the selected downlink transmission occasion, and
   to transmit the downlink channel carrying the downlink data to the communications device in accordance with the retransmission indicator.
Paragraph 60. A wireless communications system comprising a communications device according to Paragraph 49 and an infrastructure equipment according to Paragraph 58.
Paragraph 61. A computer program comprising instructions which, when loaded onto a computer, cause the computer to perform a method according to any of Paragraphs 1 to 18, Paragraphs 21 to 36, Paragraphs 40 to 48, or Paragraphs 51 to 57.
Paragraph 62. A non-transitory computer-readable storage medium storing a computer program according to Paragraph 61.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TR 38.913, “Study on Scenarios and Requirements for Next Generation Access Technologies (Release 14)”, third Generation Partnership Project, v14.3.0.
[3] RP-190726, “Physical layer enhancements for NR ultra-reliable and low latency communication (URLLC)”, Huawei, HiSilicon, RAN #83.
[4] RP-201310, “Revised WID: Enhanced Industrial Internet of Things (IoT) and ultra-reliable and low latency communication (URLLC) support for NR,” Nokia, Nokia Shanghai Bell, RAN #88e.
[5] RP-191575, “NR-based Access to Unlicensed Spectrum”, Qualcomm, RAN #84.
[6] RP-220285, “Revised SID: Study on XR Enhancements for NR”, Nokia, RAN #95e.
[7] R2-2302309 (TR38.835), “Study on XR enhancements for NR”, v1.0.2.
[8] TR 38.838, “Study on XR (Extended Reality) Evaluations for NR (Release 17)”, v17.0.0.
[9] International patent application with publication number WO 2022/018230.
[10] R1-2210002, “Power Saving Techniques for XR”, Qualcomm, RAN1 #110bis-e.

1. A method of operating a communications device configured to transmit signals to and/or to receive signals from a wireless communications network via a wireless access interface, the method comprising
determining that the communications device has uplink data to transmit to the wireless communications network,
selecting an uplink transmission occasion within a set of uplink resources of the wireless access interface to carry the uplink data to the wireless communications network, wherein the communications device selects the uplink transmission occasion based on a retransmission indicator associated with the selected uplink transmission occasion that indicates whether or not one or more retransmissions of an uplink channel are to be performed by the communications device after an initial transmission of the uplink channel in the selected uplink transmission occasion, and
transmitting the uplink channel carrying the uplink data to the wireless communications network in accordance with the retransmission indicator.

2. A method according to claim 1, comprising
receiving the retransmission indicator from the wireless communications network within radio resource control, RRC, signalling.

3. A method according to claim 2, wherein the retransmission indicator is indicated by a dedicated field within the RRC signalling.

4. A method according to claim 1, wherein the uplink channel is a configured grant of physical uplink shared channel, CG-PUSCH.

5. A method according to claim 1, wherein the selected uplink transmission occasion comprises one or more configured grant of physical uplink shared channel, CG-PUSCH, transmission occasions within a period of the CG-PUSCH configuration.

6. A method according to claim 4, comprising
receiving the retransmission indicator from the wireless communications network within an activation downlink control indication, DCI, wherein the activation DCI indicates that the CG-PUSCH is activated and is able to be used by the communications device to transmit signals to the wireless communications network.

7. A method according to claim 4, wherein the CG-PUSCH is one of a plurality of configured CG-PUSCHs in a periodic sequence, and wherein the retransmission indicator is applicable to all of the plurality of configured CG-PUSCHs in the periodic sequence.

8. A method according to claim 4, wherein the CG-PUSCH is a main CG-PUSCH which is associated with one or more supplementary CG-PUSCHs, and wherein the retransmission indicator is applicable to all of the main CG-PUSCH and the one or more supplementary CG-PUSCHs.

9. A method according to claim 4, wherein the CG-PUSCH is a main CG-PUSCH which is associated with one or more supplementary CG-PUSCHs, and wherein the retransmission indicator is applicable to only the main CG-PUSCH and not with any of the one or more supplementary CG-PUSCHs.

10. A method according to claim 9, comprising
receiving the retransmission indicator from the wireless communications network within an activation downlink control indication, DCI, wherein the activation DCI indicates that the main CG-PUSCH is activated and is able to be used by the communications device to transmit signals to the wireless communications network, and
receiving, from the wireless communications network within the activation DCI, a separate retransmission indicator for each of the one or more supplementary CG-PUSCHs.

11. A method according to claim 9, comprising
receiving, from the wireless communications network via RRC signalling, a separate retransmission indicator for each of the main CG-PUSCH and the one or more supplementary CG-PUSCHs.

12. A method according to claim 1, comprising transmitting the retransmission indicator to the wireless communications network within uplink control information, UCI.

13. A method according to claim 12, wherein the uplink channel is a configured grant of physical uplink shared channel, CG-PUSCH, and wherein the UCI is transmitted within the CG-PUSCH.

14. A method according to claim 13, wherein the UCI comprises an activation indication indicating that one or more supplementary CG-PUSCHs associated with the CG-PUSCH are activated and will be used by the communications device to transmit signals to the wireless communications network, and wherein the UCI comprises a single retransmission indicator for all of the main CG-PUSCH and the one or more supplementary CG-PUSCHs.

15. A method according to claim 13, wherein the UCI comprises an activation indication indicating that one or more supplementary CG-PUSCHs associated with the CG-PUSCH are activated and will be used by the communications device to transmit signals to the wireless communications network, and wherein the UCI comprises a separate retransmission indicator for the main CG-PUSCH and for each of the one or more supplementary CG-PUSCHs.

16. A method according to claim 1, comprising
multiplexing the uplink data from one or more logical channels of a predefined class of logical channels to the uplink channel, the uplink channel being mapped to the one or more logical channels,
wherein data multiplexed to a transport channel from any logical channel of the predefined class of logical channels does not require retransmission by the communications device after an initial transmission of the transport channel.

17. A method according to claim 1, comprising determining, if the retransmission indicator indicates that no retransmissions of the uplink channel are to be performed by the communications device after the initial transmission of the uplink channel, that the communications device is not to monitor for a retransmission resource grant from the wireless communications network.

18. A method according to claim 1, comprising determining, if the retransmission indicator indicates that no retransmissions of the uplink channel are to be performed by the communications device after the initial transmission of the uplink channel, that the communications device is not to monitor for acknowledgement feedback for the transmitted uplink channel from the wireless communications network.

19. A communications device comprising
transceiver circuitry configured to transmit signals to and/or to receive signals from a wireless communications network via a wireless access interface, and
controller circuitry configured in combination with the transceiver circuitry to determine that the communications device has uplink data to transmit to the wireless communications network,
to select an uplink transmission occasion within a set of uplink resources of the wireless access interface to carry the uplink data to the wireless communications network, wherein the communications device is configured to select the uplink transmission occasion based on a retransmission indicator associated with the selected uplink transmission occasion that indicates whether or not one or more retransmissions of an uplink channel are to be performed by the communications device after an initial transmission of the uplink channel in the selected uplink transmission occasion, and
to transmit the uplink channel carrying the uplink data to the wireless communications network in accordance with the retransmission indicator.

20.-36. (canceled)

37. An infrastructure equipment forming part of a wireless communications network, the infrastructure equipment comprising
transceiver circuitry configured to transmit signals to and/or to receive signals from a communications device via a wireless access interface, and
controller circuitry configured in combination with the transceiver circuitry to receive an initial transmission of an uplink channel from the communications device, wherein the uplink channel comprises uplink data, and
to determine, based on a retransmission indicator associated with an uplink transmission occasion in which the uplink channel was received from the communications device, whether or not one or more retransmissions of the uplink channel are to be received by the infrastructure equipment from the communications device after the initial transmission of the uplink channel.

38.-62. (canceled)
